(19) United States
(12) Patent Application Publication
(10) Pub. No.: US 2020/0273263 A1
(43) Pub. Date: Aug. 27, 2020

(54) SMART DRIVING MANAGEMENT SYSTEM AND METHOD

(71) Applicant: SOUTHERN TAIWAN UNIVERSITY OF SCIENCE AND TECHNOLOGY, TAINAN CITY (TW)

(72) Inventors: CHING-CHOU TANG, TAINAN CITY (TW); CHIEN-LIANG HSIEH, TAINAN CITY (TW); KUN-YU LI, TAINAN CITY (TW); JHIH-DENG HONG, TAINAN CITY (TW)

(21) Appl. No.: 16/871,347

(22) Filed: May 11, 2020

Related U.S. Application Data
(63) Continuation-in-part of application No. 16/233,352, filed on Dec. 27, 2018.

(51) Int. Cl. G07C 5/02; B60Q 5/00; G07C 5/00; G08G 1/0962

(52) U.S. Cl. CPC G07C 5/02; G08G 1/09626; G07C 5/008; B60Q 5/005

(57) ABSTRACT

A smart driving management system and a method are disclosed. The management system includes an onboard diagnostic unit, a processor, a voice reminding unit, and a reply receiving unit. The management method includes: executing the processor to compare the values captured by the onboard diagnostic unit with pre-stored standard values; if the values captured values do not meet the pre-stored standard values, executing the voice reminding unit to send out a voice reminder and executing the reply receiving unit to receive a voice reply; responsive to the received voice reply, executing the onboard diagnostic unit again to capture updated values of driving information from the automotive electronic control unit; and executing the processor to compare the updated values captured by the onboard diagnostic unit with the pre-stored standard values to generate a detection result that indicates whether the vehicle is in a normal driving condition or an abnormal driving condition.

### CROSS-REFERENCE TO RELATED APPLICATIONS

This application is a continuation-in-part of U.S. patent application Ser. No. 16/233,352, filed on Dec. 27, 2018, currently pending.

### FIELD OF THE INVENTION

The present invention relates to a smart driving management system and a smart driving management method for determining whether it is normal driving or dangerous driving according to the driving information of the driver and for collecting and recording the data as big data for future use to ensure the safety of the passenger.

### BACKGROUND OF THE INVENTION

Because the performance of vehicles is getting better and better, the relative driving requirements of the driver are extremely strict, so as to ensure the safety of the driver and the passengers. However, the driving behavior of every driver is different. Due to negligence, wrong operation, fatigue driving or drunk driving, there are many traffic accidents. Due to the limited capacity of traffic accident identification equipment and police identification and records officers, it is not possible to determine all traffic accidents effectively and accurately. Therefore, it is difficult to clarify the responsibilities of both parties, which may affect follow-up insurance claims.

Chinese Patent Publication No. CN103425733A, entitled “dialogue device, dialogue system, and dialogue control method” published on Dec. 4, 2013, discloses a dialog device configured to communicate with a driver driving a vehicle. The dialog comprises a storage unit, a concentration measurement unit, and a dialogue unit. The storage unit is configured to save a preference database in which a dialog option and a dialogue effect are associated with each other. The dialog option is an option for the content of the conversation with the driver. The dialogue effect indicates the degree to which the driving concentration of the driver is improved. The concentration measurement unit is configured to measure the driving concentration of the driver. The dialog unit is configured to select the dialog option based on the dialog effect in the preference database when the concentration measured by the concentration measurement unit decreases below a predetermined threshold. The dialog is then performed with the selected dialog option. The dialogue effect of the conversation is calculated based on the concentration before and after performing the conversation, and the dialogue effect of the preference database is updated.

The above patent uses the content of the language dialogue to attract the attention of the driver so as to improve the driving concentration by means of the topic of interest to the driver. However, it can only improve the concentration of the driver, and cannot correct the operation error of the driver, drunk driving or illegal driving effectively, so it is not ideal for use.

Chinese Utility Model Publication No. CN205130938U discloses a “car safety driving detection device” published on Apr. 6, 2016. During the driving, the speed sensor transmits the vehicle speed information to the central processor in time and then outputs a signal to the vehicle operating mechanism controller and the alarm module to send a voice warning to the driver through the speaker. The driver can respond accordingly via the microphone. The voice interaction module analyzes the speech rate, intonation and tone of the driver, and compares it with the information in the DRAM memory, and outputs a corresponding execution signal for normal driving or deceleration to the vehicle operating mechanism controller via the central processor.

The above patent can instantly detect whether the driver is distracted, speeding or fatigued and give corresponding warning information. If necessary, the vehicle can be forced to slow down, which helps to reduce the incidence of traffic accidents. However, the above patent only evaluates the driver's “state” based on the content of the reply, and does not further evaluate whether the driver has eliminated dangerous driving action based on the comparison of the car body condition. Therefore, it is not possible to effectively record whether the various driving behaviors of the driver are inappropriate, as a reference basis for calculating the amount of premiums when the driver is insured in the future, or as a judgment reference for the responsibility of an accident. Besides, the above patent does not detect the passage state to meet the needs of the passenger or to protect the safety of the passenger. Therefore, there are still deficiencies in use.

### SUMMARY OF THE INVENTION

In view of the above shortcomings of the prior art, the primary object of the present invention is to provide a smart driving management system and a smart driving management method.

The smart driving management system of the present invention includes an onboard diagnostic unit, a voice reminding unit, and a reply receiving unit. The onboard diagnostic unit is provided in a vehicle and is configured for communicating with a processor. The onboard diagnostic unit executes to capture values of driving information from an automotive electronic control unit of the vehicle. The voice reminding unit is provided in the vehicle and is configured for communication with the processor. The voice reminding unit executes to send out a voice reminder when the values captured by the onboard diagnostic unit do not meet pre-stored standard values. The reply receiving unit is provided in the vehicle and is configured for communication with the processor. The reply receiving unit executes to receive a voice reply after the voice reminding unit executes to send out a voice reminder. The processor is electrically connected to the onboard diagnostic unit, the voice reminding unit, and the reply receiving unit. The processor executes to receive the values of driving information captured by the onboard diagnostic unit, compare the captured values with the pre-stored standard values to determine whether to execute the voice reminding unit, and generate a detection result that indicates whether the vehicle is in a normal driving condition or an abnormal driving condition.

Preferably, the driving management system further includes an ID identification unit. The ID identification unit is provided in the vehicle configured for communication with the processor and executes to recognize whether the vehicle is driven by a qualified driver of the vehicle with a biometric identification technology.

Preferably, the voice reminding unit is provided with a smart speaker for playing the voice reminder, and the smart speaker is provided with a backup power supply. When the smart speaker is turned off improperly, the backup power supply supplies power to start the smart speaker again so that the smart speaker plays the voice reminder to warn that the smart speaker is going to be turned off.

Preferably, the driving management system further includes a voice recording unit provided in the vehicle. The voice recording unit is configured for communication with the processor and executes to record voices inside the vehicle.

The smart driving management method of the present invention includes: establishing for a vehicle an onboard diagnostic unit configured for communicating with a processor; executing the onboard diagnostic unit to capture values of driving information from an automotive electronic control unit of the vehicle; executing the processor to compare the values captured by the onboard diagnostic unit with pre-stored standard values; if the values captured by the onboard diagnostic unit do not meet the pre-stored standard values, executing a voice reminding unit to send out a voice reminder and executing a reply receiving unit to receive a voice reply; responsive to the received voice reply, executing the onboard diagnostic unit again to capture updated values of driving information from the automotive electronic control unit. The processor is electrically connected to the onboard diagnostic unit, the voice reminding unit, and the reply receiving unit. The processor executes to receive the values of driving information captured by the onboard diagnostic unit, compare the captured values with the pre-stored standard values to determine whether to execute the voice reminding unit, and generate a detection result that indicates whether the vehicle is in a normal driving condition or an abnormal driving condition.

Preferably, the smart driving management method further includes executing a voice recording unit to record voices inside the vehicle, and executing the processor to upload the recorded voices and the detection result to a cloud server for storage.

Preferably, the driving information includes a vehicle state, a driver state, and a passenger state. The vehicle state indicates whether any component of the vehicle is abnormal or faulty. The driver state indicates a driving emotion, a driving behavior, a driving speed, a brake message, a lane deviation, a detection distance of a radar, a vehicle lens image, or a combination thereof. The passenger state indicates whether a passenger designates a service item or sends a help message.

Preferable, the smart driving management method further includes, if the reply receiving unit does not receive any voice reply within an interval of time after execution of the voice reminding unit, executing the voice reminding unit to send out the voice reminder repeatedly until the reply receiving unit receives the voice reply.

Preferably, execution of the onboard diagnostic unit and the processor are sequentially and continuously performed to keep generate new detection results until an engine of the vehicle is turned off to stop driving.

Preferably, if the updated values captured by the onboard diagnostic unit meet the pre-stored standard values, the processor generates the detection result indicating that the vehicle is in the normal driving condition; if the updated values captured by the onboard diagnostic unit do not meet the pre-stored standard values, the processor generates the detection result indicating that that the vehicle is in the abnormal driving condition.

Preferably, the smart driving management method further includes executing an ID identification unit to recognize whether the vehicle is driven by a qualified driver of the vehicle with a biometric identification technology.

Preferably, execution of the reply receiving unit includes a reply analysis operation for acquiring a semantic meaning of the received voice reply to determine whether the received voice reply is meaningfully responsive to the voice reminder. The onboard diagnostic unit executes again to capture the updated values of driving information from the automotive electronic control unit only if the received voice reply is meaningfully responsive to the voice reminder.

Preferably, the smart driving management method further includes calling an emergency service for rescue when the semantic meaning of the received voice reply is to request for help.

The above technical features preferably have the following advantages:

1. The driving information can be collected and analyzed to generate a detection result, and the detection result can be uploaded to a cloud server for storage. This can prove whether the driver is in a knowing situation to carry out the dangerous driving behaviors, and can serve as a reference basis for calculating the amount of premiums of the insurance company in the future, or as a judgement reference for the responsibility of an accident.

2. By continuously detecting the driving behavior of the driver and correcting the dangerous driving behaviors of the driver through continuous voice reminders, it is possible to reduce illegal driving, wrong driving, and inadvertent driving and to improve vehicle performance. All driving information of the driver is collected, analyzed, judged and recorded as big data for future use.

3. It can effectively prevent the dangerous driving of the driver, such as speeding, running a red light, running level crossing against railing signals, snaking, changing lanes arbitrarily, turning without direction lights, not turning on headlights, not having a safe distance, improper braking, wrong shifting time, lane deviation, not paying attention to pedestrians or not paying attention to obstacles.

4. Furthermore, it is possible to detect whether the passenger state of the passenger during the driving is abnormal at any time, thereby ensuring the personal safety of the passenger while driving.

5. Furthermore, the automotive electronic diagnosis unit can detect whether the vehicle state of the vehicle is abnormal, thereby confirming whether all components of the vehicle are normal. If there is an abnormality, the voice message of the vehicle failure will be sent to remind the driver and the passenger of paying attention.

### BRIEF DESCRIPTION OF THE DRAWINGS

FIG. 1 is a block diagram of a smart driving management system according to an embodiment of the present invention;

FIG. 2 is a flow chart of a smart driving management method according to an embodiment of the present invention; and

FIG. 3 is a flow chart showing the detection of the driving information of the smart driving management method according to an embodiment of the present invention.

### DETAILED DESCRIPTION OF THE PREFERRED EMBODIMENTS

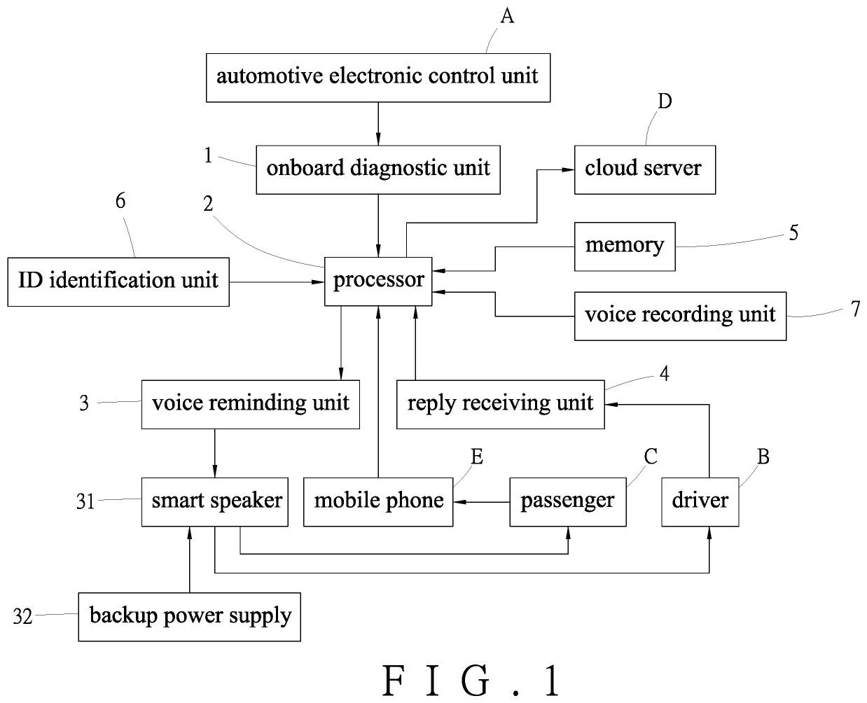

Referring to FIG. 1, a smart driving management system in accordance with an embodiment of the present invention includes an onboard diagnostic unit (1), a processor (2), a voice reminding unit (3), and a reply receiving unit (4).

The onboard diagnostic unit (1) is provided in a vehicle and configured for communicating with the processor (2). The onboard diagnostic unit (1) executes to capture values of driving information from an automotive electronic diagnosis unit (A) of the vehicle. The driving information includes a vehicle state of the vehicle, a driver state of a driver (B), and a passenger state of a passenger (C). The vehicle state includes whether any component of the vehicle is abnormal or faulty. The driver state includes the data of an emotion identification of the driver (B), a driving behavior, a vehicle speed, a brake message, a lane deviation, a detection distance of a radar, a vehicle lens image, and so on. The passenger state includes a designated service item of the passenger (C) and whether the passenger is in danger, such as shopping or sending a help message.

The smart driving management system may further include a memory (5) for pre-storing a set of standard values of driving information. The processor (2) may be a central control unit of the vehicle and is electrically connected to the onboard diagnostic unit (1), the voice reminding unit (3), and the reply receiving unit (4). The processor (2) is configured to receive the values of driving information captured by the onboard diagnostic unit (1), compare the values captured by the onboard diagnostic unit (1) with the pre-stored standard values, and generate a detection result that indicates whether the vehicle is in a normal driving condition or an abnormal driving condition. If the values captured by the onboard diagnostic unit (1) do not meet the pre-stored standard values, the a voice reminder is sent out via the voice reminding unit (3). For example, the standard value of a vehicle maximum speed is 110 km/h. When the processor (2) determines that the vehicle speed captured by the onboard diagnostic unit (1) from the automotive electronic diagnosis unit (A) exceeds 110 km/h, the processor (2) will execute the voice reminding unit (3) to send out the voice reminder. The content of the voice reminder indicates the value of the current vehicle speed to remind the driver (B) and the passenger (C) that the current vehicle speed has exceeded the standard value and that the vehicle should slow down. For example, the standard value is set as a safe distance of more than 50 m between the vehicle and a front vehicle. If it is determined that the safe distance of the vehicle is less than 50 m, the voice reminding unit (3) will execute to send out the voice reminder “should keep a safe distance”. For example, if it is determined that the low gear (3 gear or less) is not used during the up and down slopes or the wrong shifting time of the high gear (4 gear or more), the voice reminding unit (3) will execute to send out the voice reminder “should be shifted properly”. According to the values of driving information captured by the onboard diagnostic unit (1) from the automotive electronic control unit of the vehicle, it can also be determined whether the driving state of the driver (B) and the passenger state of the passenger (C) are abnormal. For example, when the vehicle has not reached the destination, that is, when the vehicle stalls for no reason or the time that the vehicle stays at any place exceeds the pre-stored standard value, the processor (2) will execute the voice reminding unit (3) to send out the voice reminder to request the driver (B) or the passenger (C) to give a correct voice reply to confirm whether there is any abnormality. It can also be determined whether the vehicle state of the vehicle is abnormal through the automotive electronic control unit (A) to confirm whether all components of the vehicle are normal. If there is an abnormality, the processor will execute the voice reminding unit (3) to send out the voice reminder to warn the driver (B) and the passenger (C) about the vehicle failure.

The voice reminding unit (3) may be a navigation device, a speeding alarm device, etc., which is electrically connected to a smart speaker (31) or a speaker device established in the vehicle, so that the voice reminder can be played to remind the driver (B) or the passenger (C) of paying attention. The smart speaker (31) may be provided with a backup power supply (32). When the smart speaker (31) is turned off improperly, the backup power supply (32) supplies power to start the smart speaker (31) again and then the smart speaker (31) plays the voice reminder to warn the driver (b) or the passenger (C) that the smart speaker (31) is going to be turned off.

The reply receiving unit (4) may be a voice assistant (such as Alexa, and Volvo voice assistant) established in the vehicle for receiving a voice reply of the driver (B) or the passenger (C) and transmits the voice reply to the processor (2). If the driver (B) or the passenger (C) does not give any voice reply within an interval after the voice reminding unit (3) sends out the voice reminder, the voice reminding unit (3) will repeatedly play the voice reminder until the reply receiving unit (4) receives the voice reply of the driver (B) or the passenger (C). For example, the driver (B) replies “knowing speeding and slowing down”. After receiving the voice reply, the reply receiving unit (1) parses the semantic meaning of the voice reply and confirms whether it corresponds to the semantic meaning of the voice reminder. If it corresponds to the semantic meaning of the voice reminder, the processor (2) executes the onboard diagnostic unit (1) to capture updated values of driving information from the automotive electronic diagnosis unit (A) according to the voice reply. The processor (2) then compares whether the updated values of driving information meet the pre-stored standard values, and generates a detection result according to the comparison. For example, the processor (2) determines whether the current vehicle speed is reduced to the standard value of less than 110 km/h. If the current vehicle speed is less than 110 km/h, the processor (2) will generate the detection result indicating that the vehicle is in a normal driving condition and the detection is terminated. If the current vehicle speed is not less than 110 km/h, the processor (2) will generate the detection result indicating that the vehicle is in an abnormal driving condition and the detection is terminated. After terminating the detection, the processor (2) starts a second detection. According to this cycle mode, the detection is continuously performed until the engine of the vehicle is turned off to stop driving, and then the detection is stopped. For example, when the reply receiving unit (4) receives the voice reply which includes shopping or a help message from the passenger (C), the reply receiving unit (4) parses the semantic meaning of the voice reply and determines whether it corresponds to the semantic meaning of the voice reminder. If it corresponds to the semantic meaning of the voice message, the processor (2) proceeds to the next step according to the voice reply, for example, performing a notification that goods are delivered to the designated place according to the specified service item, sending an alarm for rescue according to the help message.

The smart driving management method further includes a voice recording unit (7) for recording voices inside the vehicle. The processor (2) uploads the detection result and the recorded voices to a cloud server (D) for storage, which can server as a reference basis for calculating the amount of premiums of the insurance company in the future, or as a judgement reference for the responsibility of an accident, or performing a notification that goods are delivered to the designated place according to the specified service item, or sending an alarm for rescue according to the help message.

The smart driving management method further includes an ID identification unit (6) electrically connected to the processor (2). The ID identification unit (6) uses a biometric identification technology to identify whether the driver (B) is a qualified driver of the vehicle. If the driver (B) is not the qualified driver of the vehicle, the ignition system of the vehicle will be locked, so it is unable to start the engine of the vehicle. The biometric identification technology includes at least one of acoustic identification, fingerprint identification, iris identification, and face identification. The ID identification unit (6) further identifies the difference between the driver (B) and the passenger (C).

The items of the dangerous driving of the above detection result include speeding, running a red light, running level crossing against railing signals, snaking, changing lanes arbitrarily, turning without direction lights, not turning on headlights, not having a safe distance, improper braking, wrong shifting time, lane deviation, not paying attention to pedestrians or not paying attention to obstacles. The invention mainly utilizes continuous detection of the driving behavior of the driver (B) and continuous voice reminding, thereby correcting the dangerous driving behavior of the driver (B) to reduce illegal driving (for example: speeding, running a red light, running level crossing against railing signals, snaking, changing lanes arbitrarily, turning without direction lights, not turning on headlights, or not having a safe distance), wrong driving (for example: improper braking, wrong shifting time) and inadvertent driving (for example: lane deviation, not paying attention to pedestrians or not paying attention to obstacles) and to improve vehicle performance (for example, reminding the driver of shifting properly by means of a voice message). At the same time, all driving information of the driver (B) is collected, analyzed, judged and recorded as big data for future use. For example, when calculating the premium, it can refer to the number of times the driver (B) has dangerous driving to consider whether to increase the premium or not, or when clarifying the responsibility of the accident, it can be used to prove that the driver (B) is in a knowing situation to act the above dangerous driving behavior. The items of the above-mentioned dangerous driving are detected by a sensor or an advanced driver assistance system (ADAS). The present invention further detects whether an abnormality has occurred in the passenger state of the passenger (C) to ensure the safety of the passenger (C). The smart speaker (31) can play different voice reminders for different states to train the driver (B) to give a correct voice reply to recognize the emotion of the driver (B), playing the role of manual customer service.

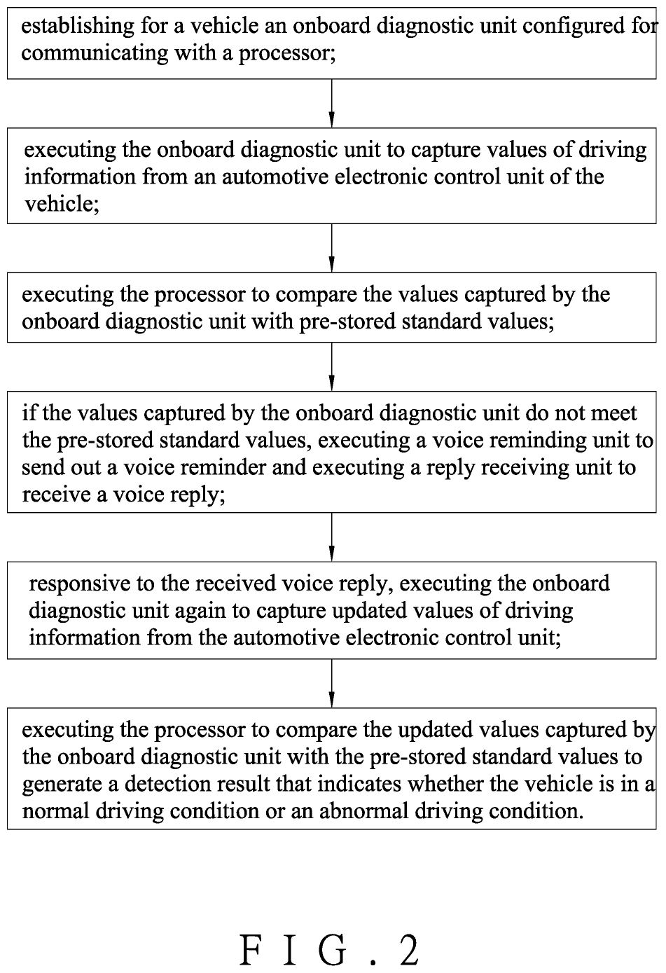

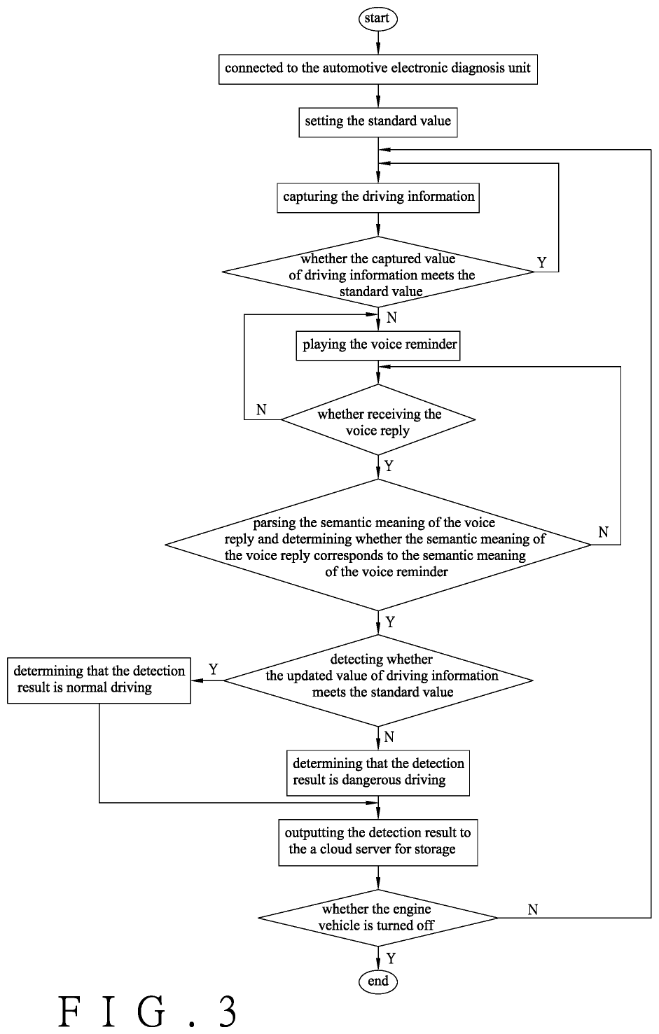

FIG. 2 and FIG. 3 illustrates a smart driving management method in accordance with an embodiment of the present invention, which is described by taking a driver (B) driving a taxi to carry a passenger (C) as an example, in cooperation with the above smart driving management system (please refer to FIG. 1), including the following steps: executing the processor (2) to compare the values captured by the onboard diagnostic unit (1) with pre-stored standard values; if the values captured by the onboard diagnostic unit (1) do not meet the pre-stored standard values, executing the voice reminding unit (3) to send out a voice reminder and executing the reply receiving unit (4) to receive a voice reply; responsive to the received voice reply, executing the onboard diagnostic unit (1) again to capture updated values of driving information from the automotive electronic control unit (A); and executing the processor (2) to compare the updated values captured by the onboard diagnostic unit (1) with the pre-stored standard values to generate a detection result that indicates whether the vehicle is in a normal driving condition or an abnormal driving condition.

The driving information includes a vehicle state, a driver state, and a passenger state. The vehicle state includes whether any component of the vehicle is abnormal or faulty, such as abnormal power output, abnormal pressure, abnormal lights, abnormal temperature, oil leakage, and so on. The driver state includes the data of a driving behavior, a vehicle speed, a brake message, a lane deviation, a detection distance of a radar, a vehicle lens image, and so on. The passenger state includes a designated service item and whether the passenger is in danger, such as shopping or sending a help message. Preferably, when the driver (B) wants to start the engine of the vehicle, he/she needs to first use the biometric identification technology of the ID identification unit (6) to identify and confirm whether the driver (B) is the qualified driver of the vehicle to avoid illegal use by others for driving the vehicle to commit a crime. When the driver (B) starts the engine of the vehicle, the smart driving management system is immediately activated to start the smart driving management method to detect the data of all driving information under the operation of the driver (B) while driving. The automotive electronic diagnosis unit (A) is used to detect whether the vehicle state of the vehicle is abnormal to confirm whether all components of the vehicle are normal.

A set of standard values or driving information are pre-stored in the memory (5). When the vehicle starts to travel, the various values of the above-mentioned driving information are generated. For example, the standard value of the set vehicle speed is 110 km/h or less. If the processor (2) determines that the vehicle speed captured by the onboard diagnostic unit (1) from the automotive electronic diagnosis unit (A) exceeds 110 km/h, the voice reminding unit (3) will be executed to send out the voice reminder through the smart speaker (31). The voice reminder indicates the value of the current vehicle speed to notify the driver (B) and the passenger (C) that the current vehicle speed has exceeded the standard value and to send a warning voice to slow down. While driving, if the driver (B) intends to harm the passenger (C), for example, if the driver (B) deliberately travels on an unscheduled route, that is, not to the destination, the smart speaker (31) will send out a warning voice message “not in the scheduled route” to remind the driver (B) and the passenger (C) of paying attention. For example, when the driver (B) has not reached the destination, that is, if the vehicle stalls for no reason or the time that the vehicle stays at any place exceeds the set standard value, the voice reminder “the vehicle stays too long” will be sent to remind the driver (B) and the passenger (C) of paying attention.

The reply receiving unit (4) receives the voice reply from the driver (B) or the passenger (C) and parses the semantic meaning of the voice reply to determine whether it corresponds to the semantic meaning of the voice reminder. For example, when the reply receiving unit (4) receives the voice reply “knowing speeding and slowing down” from the driver (B), it parses the semantic meaning of the voice reply and determine whether it corresponds to the semantic meaning of the voice reminder sent. If it corresponds to the semantic meaning of the voice reminder, the onboard diagnostic unit (1) is executed again to capture the updated values of driving information from the automotive electronic diagnosis unit (A) according to the voice reply. The processor (2) then executes to determine whether the updated value of driving information meet the pre-stored standard values.

It can also be determined whether the driver state of the driver (B) and the passenger state of the passenger (C) are abnormal. For example, when the driver (B) goes beyond the scheduled route or stays too long or the vehicle stalls for no reason, as long as the voice reply of the passenger (C) includes the meaning of “help”, when the voice reply receiving unit (4) parses the semantic meaning of the voice reply content as a help, it will immediately send an alarm for rescue through the cloud server (D) according to the help message. At the same time, the passenger (C) can directly connect the processor (2) through an APP in a mobile phone (E) for controlling the opening of the vehicle door and the opening of the vehicle window and for controlling the smart speaker (31) to sound for help. When the smart speaker (31) is forcibly turned off by the driver (B), the passenger (C) can directly uses the backup power supply (32) to supply the required power to the smart speaker (31) through the APP in the mobile phone (E), such that the smart speaker (31) is forcibly activated to warn or deter the driver (B).

In addition, the passenger (C) can make an order for shopping via the voice reply replied by the reply receiving unit (4). For example, the passenger (C) will arrive at the destination after one hour, and the goods can be ordered in advance. When the voice reply receiving unit (4) parses the semantic meaning of the voice reply as shopping, the goods will be delivered to the destination through the cloud server (D) according to the specified service item for the passenger (C) to get the goods. A mobile payment may be made through the vehicle to pay for purchases or fares.

The driver (B) may reply to the corresponding voice reply for the abnormal item of the vehicle state of the vehicle to confirm that it is known that the components of the vehicle malfunction and require immediate attention, disposal or repair.

The processor (2) generates a detection result based on the updated values of driving information, and the detection result is determined to be normal driving or dangerous driving. The processor (2) receives the updated values of driving information, and determine whether the vehicle speed exceeds the standard maximum value of 110 km/h. If the vehicle speed is less than 110 km/h, the processor (2) will generate the detection result indicating that the vehicle is in a normal driving condition and the detection is terminated. If the vehicle speed is not less than 110 km/h, the processor (2) will generate the detection result indicating that the vehicle is in an abnormal driving condition and the detection is terminated. After the detection is terminated, the processor (2) starts a second detection. Detection is performed according to this cycle mode until the vehicle reaches the destination. When the engine of the vehicle is turned off to stop driving, the detection is stopped.

Preferably, the voices inside the vehicle is recorded by the voice recording unit (7), and the processor (2) uploads the detection result and the recorded voices to a cloud server for storage. It can be used to prove that the driver is in a knowing situation to act the above dangerous driving behavior, as a reference basis for calculating the amount of premiums of the insurance company in the future, or as a judgment reference for pursuing the responsibility of an accident to ensure the safety of the passenger (C).

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A smart driving management system integrated into a vehicle, the system comprising:
an onboard diagnostic unit provided in the vehicle configured for communicating with a processor, the onboard diagnostic unit executing to capture values of driving information from an automotive electronic control unit of the vehicle;
a voice reminding unit provided in the vehicle configured for communication with the processor, the voice reminding unit executing to send out a voice reminder when the values captured by the onboard diagnostic unit do not meet pre-stored standard values;
a reply receiving unit provided in the vehicle configured for communication with the processor, the reply receiving unit executing to receive a voice reply after the voice reminding unit executes to send out a voice reminder;
wherein the processor is electrically connected to the onboard diagnostic unit, the voice reminding unit, and the reply receiving unit, the processor executing to receive the values of driving information captured by the onboard diagnostic unit, compare the captured values with the pre-stored standard values to determine whether to execute the voice reminding unit, and generate a detection result that indicates whether the vehicle is in a normal driving condition or an abnormal driving condition.

2. The smart driving management system as claimed in claim 1, further comprising an ID identification unit provided in the vehicle configured for communication with the processor, the ID identification unit executing to recognize whether the vehicle is driven by a qualified driver of the vehicle with a biometric identification technology.

3. The smart driving management system as claimed in claim 1, wherein the voice reminding unit is provided with a smart speaker for playing the voice reminder; the smart speaker is provided with a backup power supply; when the smart speaker is turned off improperly, the backup power supply supplies power to start the smart speaker again so that the smart speaker plays the voice reminder to warn that the smart speaker is going to be turned off.

4. The smart driving management system as claimed in claim 1, further comprising a voice recording unit provided in the vehicle configured for communication with the processor, the voice recording unit executes to record voices inside the vehicle.

5. A smart driving management method, comprising:
establishing for a vehicle an onboard diagnostic unit configured for communicating with a processor;
executing the onboard diagnostic unit to capture values of driving information from an automotive electronic control unit of the vehicle;
executing the processor to compare the values captured by the onboard diagnostic unit with pre-stored standard values;
if the values captured by the onboard diagnostic unit do not meet the pre-stored standard values, executing a voice reminding unit to send out a voice reminder and executing a reply receiving unit to receive a voice reply;
responsive to the received voice reply, executing the onboard diagnostic unit again to capture updated values of driving information from the automotive electronic control unit; and
executing the processor to compare the updated values captured by the onboard diagnostic unit with the pre-stored standard values to generate a detection result that indicates whether the vehicle is in a normal driving condition or an abnormal driving condition.

6. The smart driving management method as claimed in claim 5, further comprising executing a voice recording unit to record voices inside the vehicle, and executing the processor to upload the recorded voices and the detection result to a cloud server for storage.

7. The smart driving management method as claimed in claim 5, wherein the driving information includes a vehicle state, a driver state, and a passenger state, and wherein the vehicle state indicates whether any component of the vehicle is abnormal or faulty; the driver state indicates a driving emotion, a driving behavior, a driving speed, a brake message, a lane deviation, a detection distance of a radar, a vehicle lens image, or a combination thereof; the passenger state indicates whether a passenger designates a service item or sends a help message.

8. The smart driving management method as claimed in claim 5, further comprising, if the reply receiving unit does not receive any voice reply within an interval of time after execution of the voice reminding unit, executing the voice reminding unit to send out the voice reminder repeatedly until the reply receiving unit receives the voice reply.

9. The smart driving management method as claimed in claim 5, wherein execution of the onboard diagnostic unit and the processor are sequentially and continuously performed to keep generate new detection results until an engine of the vehicle is turned off to stop driving.

10. The smart driving management method as claimed in claim 5, wherein if the updated values captured by the onboard diagnostic unit meet the pre-stored standard values, the processor generates the detection result indicating that the vehicle is in the normal driving condition; if the updated values captured by the onboard diagnostic unit do not meet the pre-stored standard values, the processor generates the detection result indicating that that the vehicle is in the abnormal driving condition.

11. The smart driving management method as claimed in claim 5, further comprising executing an ID identification unit to recognize whether the vehicle is driven by a qualified driver of the vehicle with a biometric identification technology.

12. The smart driving management method as claimed in claim 5, wherein execution of the reply receiving unit includes a reply analysis operation for acquiring a semantic meaning of the received voice reply to determine whether the received voice reply is meaningfully responsive to the voice reminder, and wherein the onboard diagnostic unit executes again to capture the updated values of driving information from the automotive electronic control unit only if the received voice reply is meaningfully responsive to the voice reminder.

13. The smart driving management method as claimed in claim 12, further comprising calling an emergency service for rescue when the semantic meaning of the received voice reply is to request for help.
